(19) United States
(12) Patent Application Publication
(10) Pub. No.: US 2010/0081036 A1
(43) Pub. Date: Apr. 1, 2010

(54) ALCOHOL OXIDATION CATALYST, METHOD OF MANUFACTURING THE SAME, AND FUEL CELL USING THE ALCOHOL OXIDATION CATALYST

(75) Inventors: Chan-ho PAK, Seoul (KR); Hyuk Chang, Seongnam-si (KR); Gong Quan Sun, Dallan (CN); Lei Cao, Dallan (CN); Ming Yuan Zhu, Dallan (CN)

Correspondence Address: STEIN MCEWEN, LLP, 1400 EYE STREET, NW, SUITE 300, WASHINGTON, DC, 20005, US

(73) Assignees: Samsung Electronics Co., Ltd., Suwon-si (KR); Dalian Institute of Chemical Physics, Dalian (CN); Chinese Academy of Sciences, Dalian (CN)

(21) Appl. No.: 12/567,038

(22) Filed: Sep. 25, 2009

(30) Foreign Application Priority Data
Sep. 26, 2008 (CN) 200810173761.1
Nov. 28, 2008 (KR) 10-2008-0119937

(51) Int. Cl. H01M 4/92; B01J 23/42

(52) U.S. Cl. 429/44; 502/339

(57) ABSTRACT

An ethanol oxidation catalyst including a Pt/Ru alloy and tin(II) oxide or tin(IV) oxide, a method of manufacturing the same, an electrode for a fuel cell including the ethanol oxidation catalyst, and a fuel cell having excellent power generation efficiency using the electrode.

### CROSS-REFERENCE TO RELATED APPLICATIONS

This application claims the benefit of Chinese Patent Application No. 200810173761.1, filed Sep. 26, 2008 in the State Intellectual Property Office of China, and Korean Application No. 10-2008-0119937, filed Nov. 28, 2008 in the Korean Intellectual Property Office, the disclosures of which are incorporated herein by reference.

### BACKGROUND OF THE INVENTION

1. Field of the Invention

One or more embodiments relate to an alcohol oxidation catalyst, a method of manufacturing the same, and a fuel cell using the alcohol oxidation catalyst.

2. Description of the Related Art

Fuel cells chemically decompose a fuel and convert chemical energy of the fuel directly into electrical energy. Thus, fuel cells are useful in various industrial fields. In this regard, research has been conducted on using methanol as a direct fuel in low temperature fuel cells.

A Pt—Ru binary alloy catalyst is used in direct methanol fuel cells (DMFCs) in order to mitigate the adsorption of carbon monoxide generated in the oxidation of methanol.

However since methanol is harmful to the human body, there is a need to develop a fuel that can be used instead of methanol. Therefore, a variety of methods of using ethanol, which is not as harmful to the human body, in place of methanol have been attempted.

As ethanol oxidation catalysts, a Pt—Ru binary alloy catalyst used for oxidation of methanol, or a catalyst including Pt and one of W, Sn, Mo, Cu, Au, Mn, and V have been disclosed (JP 2004-152748A) (essentially equivalent to U.S. Patent Publication No. 2008/0032885). However, these catalysts do not have sufficient activity for ethanol oxidation, and thus there is a need to improve activity for ethanol oxidation.

### SUMMARY

One or more embodiments include an ethanol oxidation catalyst having excellent ethanol oxidation activity, a method of manufacturing the same, an electrode for a fuel cell including the ethanol oxidation catalyst, and a direct ethanol fuel cell including the electrode.

According to one or more embodiments, an ethanol oxidation catalyst includes a Pt/Ru alloy and tin(II) oxide or tin(IV) oxide, wherein the molar ratio of the Pt/Ru alloy to the tin(II) oxide or tin(IV) oxide is 2.5-3.5:1.

According to one or more embodiments, a method of manufacturing an ethanol oxidation catalyst includes: dissolving each of a Pt precursor, an Ru precursor, and an Sn precursor in separate portions of a first solvent, and mixing solutions of the precursors; mixing a catalyst support and a second solvent; preparing a supported catalyst by mixing the metal salt precursor solution and the catalyst support solution and adjusting the pH of the mixture in a basic direction to load particles of the catalyst on the catalyst support; initially heat treating the resultant at a temperature of about 50 to about 70° C.; then heat treating the resultant at a temperature of about 125 to about 160° C.; readjusting the pH of the resultant in an acidic direction; and isolating and washing the supported catalyst.

Additional aspects and/or advantages of these embodiments will be set forth in part in the description which follows and, in part, will be obvious from the description, or may be learned by practice of the invention.

### BRIEF DESCRIPTION OF THE DRAWINGS

These and/or other aspects will become apparent and more readily appreciated from the following description of the embodiments, taken in conjunction with the accompanying drawings of which:

FIG. 1 is a flowchart illustrating a process of manufacturing an ethanol oxidation catalyst, according to an embodiment;

FIG. 2 is a graph illustrating the X-ray diffraction pattern (XRD) of a Pt/Ru alloy supported catalyst prepared according to Example 1;

FIG. 3A is a graph illustrating power density with respect to current density for fuel cells manufactured according to Preparation Example 1 and Comparative Preparation Example 1; and

FIG. 3B is a graph illustrating cell voltage with respect to current density for fuel cells manufactured according to Preparation Example 1 and Comparative Preparation Example 1.

### DETAILED DESCRIPTION

Reference will now be made in detail to the present embodiments, examples of which are illustrated in the accompanying drawings. The embodiments are described below in order to explain the present invention by referring to the figures.

An ethanol oxidation catalyst according to an embodiment includes a Pt/Ru alloy and tin(II) oxide or tin(IV) oxide. The molar ratio of Pt and Ru to the tin(II) oxide or tin(IV) oxide may be about 2.5-3.5:1, preferably, 2.9-3.1:1, and more preferably 3.0:1 in the ethanol oxidation catalyst. If the molar ratio of Pt and Ru to the tin(II) oxide or tin(IV) oxide is less than 2.5:1, the initial oxidation reactivity of ethanol is reduced. On the other hand, if the molar ratio of Pt and Ru to the tin(II) oxide or tin(IV) is greater than 3.5:1, intermediates generated by oxidation are not sufficiently removed.

In the ethanol oxidation catalyst, the molar ratio of Pt to Ru may be about 3-15:1, and preferably 4-14:1. If the molar ratio of Pt to Ru is greater than 15:1, ethanol oxidation capacity may be reduced. On the other hand, if the molar ratio of Pt to Ru is less 3:1, it is difficult to remove CO. The ethanol oxidation catalyst may further include a support on which the Pt/Ru alloy and the tin(II) oxide or tin(IV) oxide are loaded. The amount of the support may be about 50 to about 90 parts by weight based on 100 parts by weight of the ethanol oxidation catalyst.

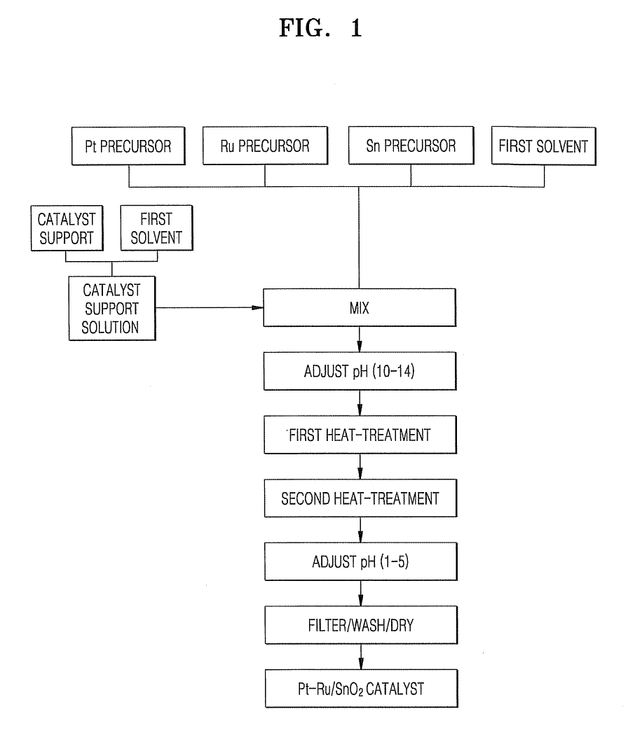

Hereinafter, a method of manufacturing an ethanol oxidation catalyst according to an embodiment will be described with reference FIG. 1. First, a Pt precursor and an Ru precursor, and an Sn precursor are each dissolved in separate portions of a first solvent.

The molar ratio among the Pt precursor, the Ru precursor, and the Sn precursor may be quantified such that the molar ratio of Pt and Ru to SnO₂ contained in the final ethanol oxidation catalyst can be about 2.5-3.5:1. If the molar ratio among the Pt precursor, Ru precursor, and Sn precursor is not within the range described above, the desired ratio of each component in the final supported catalyst is not obtained.

The first solvent may be water or a polyol. The water may be deionized water, and the polyol may be ethylene glycol, triethylene glycol, or the like. Each of the Pt precursor, the Ru precursor and the Sn precursor may be dissolved in polyols.

To dissolve the Pt precursor, the amount of the first solvent may be about 3000 to about 9000 parts by weight based on 100 parts by weight of the Pt precursor. To dissolve the Ru precursor, the amount of the first solvent may be about 7000 to about 26000 parts by weight based on 100 parts by weight of the Ru precursor. To dissolve the Sn precursor, the amount of the first solvent may be about 4000 to about 15000 parts by weight based on 100 parts by weight of the Sn precursor.

The Pt precursor may be a salt that easily dissolves in water, such as Pt chloride, Pt sulfate, or Pt nitrate; examples include, but are not limited to, H₂PtCl₆, H₂PtCl₆.xH₂O, K₂PtCl₄, PtCl₂, Pt(NH₃)₄Cl₂, Pt(NH₃)₄(NO₃)₂, and (NH₃)₂Pt(NO₂)₂. The Ru precursor may also be a salt which easily dissolves in water, such as Ru chloride, Ru sulfate, or Ru nitrate; examples include, but are not limited to, RuCl₃, RuCl₃.H₂O, K₂RuCl₅, and (NH₄)₂RuCl₆. In addition, the Sn precursor may be SnCl₄.5H₂O, SnCl₂.2H₂O, Sn(C₂H_{S}O)₄, K₂SnO₃, or the like. The Pt precursor, the Ru precursor, and the Sn precursor are respectively dissolved in separate portions of the first solvent to form a Pt precursor solution, an Ru precursor solution, and an Sn precursor solution, which are then mixed to prepare a metal salt solution.

A catalyst support, which supports the active components, is dispersed in a second solvent to prepare a support solution. The catalyst support may be a carbonaceous support, zeolite, silica/alumina, or the like, and preferably a carbonaceous support or zeolite. The carbonaceous support may be graphite, carbon powder, acetylene black, carbon black, activated carbon, mesoporous carbon, carbon nanotube, carbon nanofiber, carbon nanohorn, carbon nanoring, carbon nanowire, fullerene (C₆₀), or the like. The second solvent used to disperse the catalyst support may be ethylene glycol, water, triethylene glycol, or the like.

The metal salt solution and the support solution are then mixed, and the pH of the mixture is adjusted to be in a range of 10 to 14 using a pH adjusting agent. The pH adjusting agent may be an alkaline solution such as NaOH, NH₄OH, KOH, Ca(OH)₂, or the like. If the pH of the mixture is lower than the range described above, the amount of Pt, Sn, and Ru remaining in solution increases. Thus, the amount of catalyst loaded on the support is reduced, and the supported catalyst agglomerates. If the pH of the mixture is higher than the range described above, the particle diameter of the catalyst may be increased.

The mixture having the adjusted pH is first heat treated at a temperature of about 50 to about 70° C., and particularly, at about 60° C. The mixture may be heat-treated at a heating rate increase of about 3 to 7° C./min. If the temperature during the first heat-treatment does not reach 50° C., there is insufficient reduction of the metals. On the other hand, if the temperature during the first heat-treatment exceeds 70° C., particles may grow, making the catalyst particle size distribution non-uniform. If the heating rate is less than the range described above, the reaction rate is decreased, and nucleation is not uniform. If the heating rate is greater than the range described above, the reaction rate is increased, and the particle size distribution is not as uniform as desired.

After the first heat-treatment process, a second heat-treatment is performed at a temperature of about 125 to about 160° C., and preferably at about 140° C. The heating increase rate during the second heat-treatment may be about 3 to 7° C./min. If the temperature of the second heat-treatment does not reach 125° C., there is insufficient reduction of the metals. If the temperature of the second heat-treatment exceeds 160° C., the particle size increases too much. If the heating increase rate is less than the range described above, the particle size is increased too much. If the heating increase rate is greater than the range described above, particles do not grow uniformly, and thus the particle size distribution of the catalyst may not be uniform. Reduction occurs primarily at the temperature of the second heat-treatment.

Then, the pH of the mixture is adjusted to a range of about 1 to about 5 using an acidic solution such as HCl. If the pH of the mixture is less than 1, the alloy formed may dissolve in the mixture due to high acidity. If the pH of the mixture is greater than 5, the interaction between the catalyst particles and the support decreases, and thus the catalyst particles are not sufficiently loaded on the support but remain in the solution.

According to this embodiment, the resultant product is isolated using a conventional method such as filtration and centrifugation, and washed to prepare an ethanol oxidation catalyst. Through these two processes of dissolving the precursors in polyols and the two-stage heat-treatment as described above, an ethanol oxidation catalyst may be prepared having catalyst particles including a Pt/Ru alloy and tin(II) oxide or tin(IV) oxide loaded on the support. The ethanol oxidation catalyst has excellent dispersibility even when a large amount of metal is loaded on the support, and increased activity for promoting ethanol oxidation.

The total weight of the Pt/Ru alloy and the tin(II) oxide or tin(IV) oxide may be about 50 to about 90 parts based on 100 parts by weight of the ethanol oxidation catalyst. If the total weight of the Pt/Ru alloy and the tin(II) oxide or tin(IV) oxide is less than 50 parts by weight based on 100 parts by weight of the ethanol oxidation catalyst, the thickness of an anode catalyst layer prepared using the ethanol oxidation catalyst needs to be increased, and thus electric resistance is too high. If the total weight of the Pt/Ru alloy and the tin(II) oxide or tin(IV) oxide is greater than 90 parts by weight based on 100 parts by weight of the ethanol oxidation catalyst, the particle diameter of the catalyst will be greater than 10 nm or the particles agglomerate, and thus the specific surface area decreases.

The support for the Pt/Ru alloy and the tin(II) oxide or tin(IV) oxide may be a carbonaceous support, zeolite, silica/alumina, or the like, and preferably a carbonaceous support or zeolite. The carbonaceous support may be graphite, carbon powder, acetylene black, carbon black, activated carbon, mesoporous carbon, carbon nanotube, carbon nanofiber, carbon nanohorn, carbon nanoring, carbon nanowire, fullerene (C₆₀), or the like.

In the ethanol oxidation catalyst according to this embodiment, a diffraction peak corresponding to the Pt/Ru alloy is observed at a Bragg (2θ) angle of 35 to 50 degrees when a Cu Kα X-ray having a wavelength of 1.541 nm is used for radiation. The diffraction peaks may be obtained from the Pt (111) plane or Pt (200) plane of the ethanol oxidation catalyst. The main diffraction peaks corresponding to SnO₂ are observed at about 34 degrees and at about 52 degrees. Thus, it can be seen that the Pt/Ru alloy and nano-sized SnO₂ are closely dispersed and co-exist. The X-ray diffraction properties were analyzed using Cu Kα X-rays generated at 45 kV at 40 mA by a diffractometer (Shimadzu model XRD-6000). In addition, quantitative analysis of the Pt/Ru alloy and the tin(II) oxide or tin(IV) oxide in the ethanol oxidation catalyst may be conducted by inductively coupled plasma (ICP).

Meanwhile, the ethanol oxidation catalyst prepared using the manufacturing process according to this embodiment may be used as an active ingredient promoting ethanol oxidation of ethanol in an electrode of a fuel cell, particularly in an anode electrode, and may be used for an electrode for a fuel cell using a conventional method.

The ethanol oxidation catalyst is dispersed with a dispersing agent such as isopropyl alcohol, tetrabutyl acetate, and n-butyl acetate, and a perfluorosulfonic acid ionomer such as NAFION (® The Dupont Company) to prepare a slurry. Then the slurry is coated on a gas diffusion layer.

The gas diffusion layer includes a support substrate and a carbon layer. The carbon layer may be formed by mixing carbon black with a solvent such as isopropyl alcohol and a binder such as poly(tetrafluoroethylene) (PTFE), and coating the mixture on the support substrate. Then, the resultant is dried and heat-treated.

The support substrate may be carbon cloth or carbon paper. If carbon paper is used, it is preferably water-repellent carbon paper, and more preferably water-repellent carbon paper to which a water-repellent carbon black layer is applied.

The water-repellent carbon paper may include about 5 to about 50% by weight of a hydrophobic polymer such as PTFE, and the hydrophobic polymer may be sintered. The gas diffusion layer is treated to be water-repellent to ensure the entry/exit path of both polar liquid reactants and gaseous reactants.

In the water-repellent carbon paper having the water-repellent carbon black layer, the water-repellent carbon black layer includes carbon black and about 20 to about 50% by weight of a hydrophobic polymer, such as PTFE, as a hydrophobic binder. The water-repellent carbon black layer is applied to a side of the water-repellent carbon paper. The hydrophobic polymer in the water-repellent carbon black layer is sintered.

Furthermore, a fuel cell according to another embodiment may include a cathode including a catalyst layer and a gas diffusion layer; an anode including a catalyst layer and a gas diffusion layer; and an electrolyte membrane interposed between the cathode and the anode, wherein at least one of the cathode and the anode, particularly the anode, may include an ethanol oxidation catalyst prepared according to another embodiment disclosed above.

The fuel cell may be used in a direct ethanol fuel cell (DEFC). The fuel cell may be prepared using a method that is commonly used in manufacturing fuel cells, and the method will not be described here in detail. The direct ethanol fuel cell has the same configuration as that of a direct methanol fuel cell.

Embodiments disclosed above provide an ethanol oxidation catalyst having excellent ethanol oxidation activity, a method of manufacturing the same, an electrode for a fuel cell including the ethanol oxidation catalyst, and a fuel cell having excellent power generation efficiency using the electrode. Hereinafter, one or more embodiments will be described in detail with reference to the following examples. However, these examples are not intended to limit the purpose and scope of the embodiments.

### Example 1

### Preparation of Ethanol Oxidation Catalyst

H₂PtCl₆.xH₂O, SnCl₂ and RuCl₃.H₂O were completely dissolved in 50 ml of ethylene glycol while stirring to prepare a metal salt solution. The amounts of H₂PtCl₆.xH₂O, SnCl₂ and RuCl₃.H₂O were adjusted such that the molar ratio among Pt. SnO₂ and Ru was 2.6:1:0.4 in a finally prepared catalyst.

0.370 g of carbon black support was dispersed in 100 ml of ethylene glycol while stirring to prepare a uniform dispersion of a catalyst support solution. The prepared catalyst support solution was added to the metal salt solution, and the pH of the mixture was adjusted to 13 using an NaOH solution.

The resultant was first heated to 60° C. over 30 minutes using an oil bath, then heated to 140° C. over 30 minutes, and the temperature was maintained for 2 hours. When the reaction was terminated, the pH of the mixture was adjusted to 3 using an HCl solution to form catalyst particles. The formed catalyst particles were isolated by filtration and washed with hot ion exchanged water.

Then the resultant was dried at 80° C. in an oven to prepare an ethanol oxidation catalyst including the Pt/Ru alloy and the stannic oxide (SnO₂). In the ethanol oxidation catalyst, the amount of the catalyst particles formed from the Pt/Ru alloy and the stannic oxide (SnO₂) was 80 parts by weight based on 100 parts by weight of the ethanol oxidation catalyst.

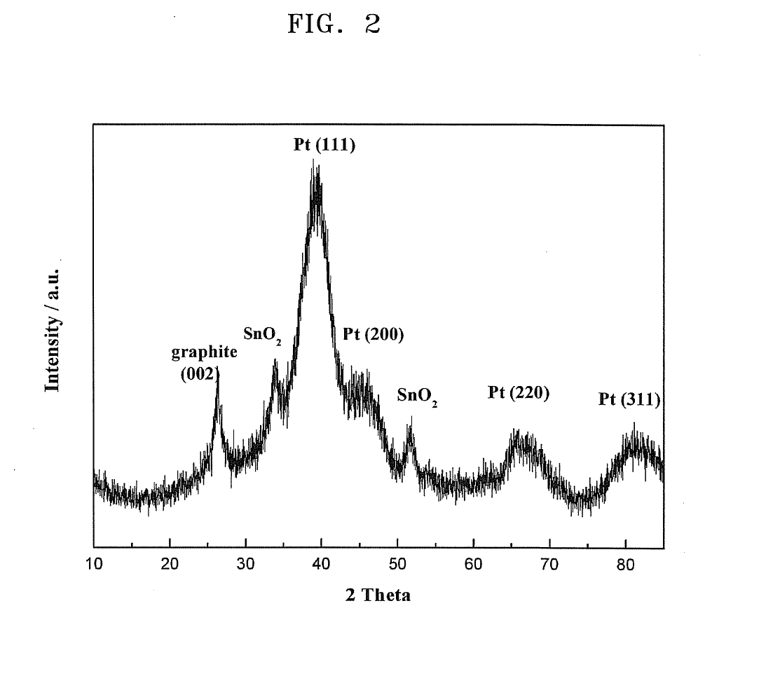

XRD diffraction properties of the ethanol oxidation catalyst prepared according to Example 1 were measured, and the results are shown in FIG. 2. Referring to FIG. 2, at a Bragg (2θ) angle of 30˜50 degrees a diffraction peak of Pt was observed, but no diffraction peak of Ru was observed. Thus, it can be seen that Pt and Ru formed an alloy. A diffraction peak of Sn was observed at a Bragg (2θ) angle of 34 degrees. The composition of the ethanol oxidation catalyst according to these embodiments may be identified by inductively coupled plasma (ICP).

### Example 2

### Preparation of Ethanol Oxidation Catalyst

An ethanol oxidation catalyst was prepared in the same manner as in Example 1, except that the amount of H₂PtCl₆.xH₂O, SnCl₂ and RuCl₃.H₂O was adjusted such that the molar ratio among Pt, Sn and Ru was 2.8:1.0:0.2 in a finally prepared catalyst.

### Example 3

### Preparation of Ethanol Oxidation Catalyst

An ethanol oxidation catalyst was prepared in the same manner as in Example 1, except that the amount of H₂PtCl₆.xH₂O, SnCl₂ and RuCl₃.H₂O was adjusted such that the molar ratio among Pt, SnO₂ and Ru was 2.4:1.0:0.2 in a finally prepared catalyst.

### Comparative Example 1

### Preparation of Ethanol Oxidation Catalyst

An ethanol oxidation catalyst was prepared in the same manner as in Example 1, except that the amount of H₂PtCl₆.xH₂O, SnCl₂ and RuCl₃.H₂O was adjusted such that the molar ratio among Pt, SnO₂ and Ru was 3.0:1.0:1.0 in a finally prepared catalyst.

### Comparative Example 2

### Preparation of Ethanol Oxidation Catalyst

An ethanol oxidation catalyst was prepared in the same manner as in Example 1, except that the amount of H₂PtCl₆.xH₂O, SnCl₂ and RuCl₃.H₂O was adjusted such that the molar ratio among Pt, SnO₂ and Ru was 2.0:1.0:2.0 in a finally prepared catalyst.

### Comparative Example 3

### Preparation of Ethanol Oxidation Catalyst

An ethanol oxidation catalyst was prepared in the same manner as in Comparative Example 1, except that the first heating temperature was 120° C.

### Comparative Example 4

### Preparation of Ethanol Oxidation Catalyst

An ethanol oxidation catalyst was prepared in the same manner as in Comparative Example 1, except that the second heating temperature was 220° C.

Average particle diameter and particle distribution of the ethanol oxidation catalyst including the Pt/Ru—SnO₂ prepared according to Examples 1-3 and Comparative Examples 1-4 were measured, and the results are shown in Table 1.

TABLE 1

| | | Average | |
|---|---|---|---|
| | | particle | |
| | Pt:SnO₂:Ru | diameter of | |
| | (molar ratio) | catalyst (nm) | Dispersibility * |
| Example 1 | 2.6:1.0:0.4 | 2.5 | good |
| Example 2 | 2.8:1.0:0.2 | 2.3 | good |
| Example 3 | 2.4:1.0:0.6 | 2.5 | good |
| Comparative Example 1 | 3.0:1.0:1.0 | 3.2 | poor |
| Comparative Example 2 | 2.0:1.0:2.0 | 3.2 | poor |
| Comparative Example 3 | 3.0:1.0:1.0 | 2.9 | poor |
| Comparative Example 4 | 3.0:1.0:1.0 | 3.1 | poor |
| Example 4 | 2.1:1.0:0.4 | 2.7 | good |
| Example 5 | 2.9:1.0:0.6 | 2.9 | good |
| Comparative Example 5 | 2.0:1.0:0.4 | 2.9 | poor |
| Comparative Example 6 | 3.0:1.0:0.6 | 3.1 | poor |

Dispersibility shown in Table 1 is evaluated by observing the agglomeration of catalyst particles using transmission electron microscopy (TEM). In this regard, the agglomeration of the catalyst particles was determined as poor when the amount of the agglomerated particles was greater than 30% based on the amount of the total catalyst particles.

### Example 4

### When the Molar Ratio of Pt and Ru to SnO₂ was 2.5:1

An ethanol oxidation catalyst was prepared in the same manner as in Example 1, except that the amount of H₂PtCl₆.xH₂O, SnCl₂ and RuCl₃.H₂O was adjusted such that the molar ratio among Pt, SnO₂ and Ru was 2.1:1.0:0.4 in a finally prepared catalyst.

### Example 5

### When the Molar Ratio of Pt and Ru to SnO₂ was 3.5:1

An ethanol oxidation catalyst was prepared in the same manner as in Example 1, except that the amount of H₂PtCl₆.xH₂O, SnCl₂ and RuCl₃.H₂O was adjusted such that the molar ratio among Pt, SnO₂ and Ru was 2.9:1.0:0.6 in a finally prepared catalyst.

### Comparative Example 5

### When the molar ratio of Pt and Ru to SnO₂ was Less than 2.5:1

An ethanol oxidation catalyst was prepared in the same manner as in Example 1, except that the amount of H₂PtCl₆.xH₂O, SnCl₂ and RuCl₃.H₂O was adjusted such that the molar ratio among Pt, SnO₂ and Ru was 2.0:1.0:0.4 in a finally prepared catalyst.

### Comparative Example 6

### When the Molar Ratio of Pt and Ru to SnO₂ was Greater than 3.5:1

An ethanol oxidation catalyst was prepared in the same manner as in Example 1, except that the amount of H₂PtCl₆.xH₂O, SnCl₂ and RuCl₃.H₂O was adjusted such that the molar ratio among Pt, SnO₂ and Ru was 3.0:1.0:0.6 in a finally prepared catalyst.

Referring to Table 1, the ethanol oxidation catalysts prepared according to Examples 1 to 5 have a smaller particle diameter and better dispersibility than those prepared according to Comparative Examples 1 to 3.

### Preparation Example 1

### Preparation of Fuel Cell

An electrode for a fuel cell was prepared using an ethanol oxidation catalyst prepared according to Example 1. In the supported catalyst, the weight of the Pt/Ru alloy was 80 parts by weight based on 100 parts by weight of the supported catalyst. The amount of the ethanol oxidation catalyst loaded on an anode electrode was 3.8 mg/cm², and the amount of Pt black catalyst loaded on a cathode electrode was 6.3 mg/cm².

NAFION 115 was used as the electrolyte membrane, and the temperature of the fuel cell was 50° C. Air was used in the cathode, and a 1M methanol solution was used in the anode.

### Preparation Examples 2 and 3

Fuel cells were prepared in the same manner as in Preparation Example 1, except that the ethanol oxidation catalysts prepared according to Examples 2 and 3 were used instead of the ethanol oxidation catalyst prepared according to Example 1.

### Comparative Preparation Examples 1 to 4

Fuel cells were prepared in the same manner as in Preparation Example 1, except that the anode was prepared using the ethanol oxidation catalysts prepared according to Comparative Examples 1 to 4.

Maximum power of the fuel cells prepared according to Preparation Examples 1 to 3 and Comparative Preparation Examples 1 to 4 was measured, and the results are shown in Table 2 below.

TABLE 2

| | Power density |
|---|---|
| | (mW/cm²) at 40□ |
| Preparation Example 1 | 23 |
| Preparation Example 2 | 18 |
| Preparation Example 3 | 20 |
| Comparative Preparation Example 1 | 10 |
| Comparative Preparation Example 2 | 8 |
| Comparative Preparation Example 3 | 6 |
| Comparative Preparation Example 4 | ≈0 |

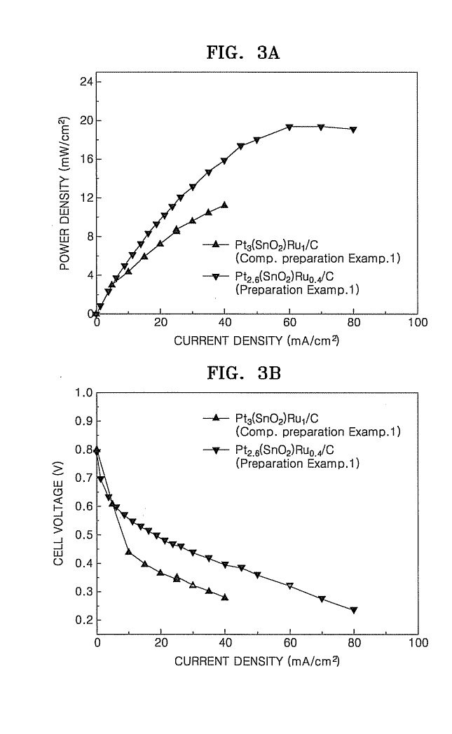

Referring to Table 2, the fuel cells prepared according to Preparation Examples 1 to 3 have better power characteristics than those prepared according to Comparative Preparation Examples 1 to 4. Cell voltage and power density with respect to current density of the fuel cells prepared according to Preparation Example 1 and Comparative Preparation Example 1 were measured, and the results are shown in FIG. 3.

Referring to FIGS. 3A and 3B, the fuel cell prepared according to Preparation Example 1 has significantly greater power density, about twice as much, than the fuel cell prepared according to Comparative Preparation Example 1. Also, the fuel cell prepared according to Preparation Example 1 has significantly improved cell voltage with respect to the fuel cell prepared according to Comparative Preparation Example 1. Thus, it can be seen that the activity of the ethanol oxidation catalyst prepared according to these embodiments is greater than that of a conventional catalyst.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An ethanol oxidation catalyst comprising a Pt/Ru alloy and tin(II) oxide or tin(IV) oxide, wherein the molar ratio of the Pt/Ru alloy to the tin(II) oxide or tin(IV) oxide is about 2.5-3.5:1.

2. The ethanol oxidation catalyst of claim 1, wherein the molar ratio of Pt to Ru is about 3-15:1 in the Pt/Ru alloy.

3. The ethanol oxidation catalyst of claim 1, wherein a main peak is observed at a Bragg (2θ) angle of 30 to 50 degrees when Cu Kα X-rays having a wavelength of 1.541 nm are the radiation source.

4. The ethanol oxidation catalyst of claim 1, further comprising a support on which the Pt/Ru alloy and the tin(II) oxide or tin(IV) oxide are loaded.

5. The ethanol oxidation catalyst of claim 4, wherein the amount of the support is about 50 to about 90 parts by weight based on 100 parts by weight of the ethanol oxidation catalyst.

6. A method of manufacturing an ethanol oxidation catalyst, the method comprising:
dissolving each of a Pt catalyst precursor an Ru catalyst precursor, and an Sn catalyst precursor, in separate portions of a first solvent, and mixing the solutions of the precursors;
dispersing a catalyst support in a second solvent;
mixing the metal salt precursor solution and the catalyst support solution;
adjusting the pH of the resultant mixture in a basic direction;
initially heat treating the resultant at a temperature of about 50 to about 70° C.;
then heat treating the resultant at a temperature of about 125 to about 160° C.;
adjusting the pH of the resultant in an acidic direction; and
isolating and washing the supported catalyst.

7. The method of claim 6, wherein the heating increase rate of the first heat-treatment process is about 3 to 7° C./min.

8. The method of claim 6, wherein the heating increase rate of the second heat-treatment process is about 3 to 7° C./min.

9. The method of claim 6, wherein the molar ratio of Pt in the Pt precursor to Ru in the Ru precursor is about 3:1 to about 15:1.

10. The method of claim 6, wherein the pH for loading particles of the catalyst on the catalyst support is adjusted to 10-14.

11. The method of claim 6, wherein, in adjusting the pH of the resultant, the pH is adjusted to be in a range of 1-5.

12. An electrode for a fuel cell comprising an ethanol oxidation catalyst comprising a Pt/Ru alloy and a tin(II) oxide or tin(IV) oxide, wherein the molar ratio of the Pt/Ru alloy to the tin(II) oxide or tin(IV) oxide is 2.5-3.5:1.

13. The electrode of claim 12, wherein the molar ratio of Pt to Ru is about 3-15:1 in the Pt/Ru alloy.

14. The electrode of claim 12, further comprising a support on which the Pt/Ru alloy and the tin(II) oxide or tin(IV) oxide are loaded.

15. The ethanol oxidation catalyst of claim 14, wherein the amount of the support is about 50 to about 90 parts by weight based on 100 parts by weight of the ethanol oxidation catalyst.

16. The ethanol oxidation catalyst of claim 12, wherein a main peak of the ethanol oxidation catalyst is observed at a Bragg (20) angle of 30 to 50 degrees when Cu Kα X-rays having a wavelength of 1.541 nm are the irradiation source.

17. A fuel cell comprising:
a cathode;
an anode; and
an electrolyte membrane interposed between the cathode and the anode,
wherein at least one of the cathode and the anode comprises an ethanol oxidation catalyst comprising a Pt/Ru alloy and tin(II) oxide or tin(IV) oxide, wherein the molar ratio of the Pt/Ru alloy to the tin(II) oxide or tin(IV) oxide is 2.5-3.5:1.

18. The fuel cell of claim 17, wherein the molar ratio of Pt to Ru is 3-15:1 in the Pt/Ru alloy.

19. The fuel cell of claim 17, further comprising a support on which the Pt/Ru alloy and the tin(II) oxide or tin(IV) oxide are loaded.

20. The fuel cell of claim 19, wherein the amount of the support is about 50 to about 90 parts by weight based on 100 parts by weight of the ethanol oxidation catalyst.

21. The electrode of claim 12, wherein the molar ratio of the Pt/Ru alloy to the tin(II) oxide or tin(IV) oxide is 3.0:1.0.

22. The electrode of claim 13, wherein the molar ratio of Pt to Ru is in the range of 4-14:1 in the Pt/Ru alloy.

23. The fuel cell of claim 17, wherein the cathode and the anode each contain a catalyst layer and a gas diffusion layer.

24. The fuel cell of claim 17, wherein the anode comprises an ethanol oxidation catalyst comprising a Pt/Ru alloy and tin(II) oxide or tin(IV) oxide, wherein the molar ratio of the Pt/Ru alloy to the tin(II) oxide or tin(IV) oxide is 2.5-3.5:1.
